(19) United States
(12) Patent Application Publication
(10) Pub. No.: US 2025/0095527 A1
(43) Pub. Date: Mar. 20, 2025

(54) MANUFACTURING METHOD OF ELECTRONIC DEVICE

(71) Applicant: Innolux Corporation, Miaoli County (TW)

(72) Inventors: I-Chun Lu, Miaoli County (TW); Bing-Ting Dong, Miaoli County (TW); Tzu-Yun Lin, Miaoli County (TW); Tsui-Hua Hung, Miaoli County (TW)

(73) Assignee: Innolux Corporation, Miaoli County (TW)

(21) Appl. No.: 18/805,536

(22) Filed: Aug. 15, 2024

(30) Foreign Application Priority Data
Sep. 14, 2023 (CN) 202311187482.1

(51) Int. Cl. G09G 3/00

(52) U.S. Cl. CPC G09G 3/006; G09G 2320/0271; G09G 2320/103

(57) ABSTRACT

A manufacturing method of an electronic device is provided. The manufacturing method of the electronic device includes a detection step. The detection step is used to detect the pressure distribution of a manufacturing element. The detection step includes: providing a detection element; pressing the manufacturing element on the detection element to generate a plurality of indentation patterns; converting the plurality of indentation patterns into a plurality of image data; using the plurality of image data to calculate an image feature value; and comparing a relationship between the image feature value and a threshold, and generating a comparison result.

### CROSS-REFERENCE TO RELATED APPLICATION

This application claims the priority benefit of China application serial no. 202311187482.1, filed on Sep. 14, 2023. The entirety of the above-mentioned patent application is hereby incorporated by reference herein and made a part of this specification.

### BACKGROUND

### Technical Field

The disclosure relates to a manufacturing method of an electronic device, and in particular relates to a manufacturing method including a detection step to manufacture an electronic device.

### Description of Related Art

Manufacturing equipment may process products using manufacturing elements to manufacture electronic devices. The state of manufacturing elements directly or indirectly affects the quality of the product. Generally speaking, inspectors determines the state of manufacturing element. For example, the inspector may control the manufacturing element to press on the detection element (e.g., pressure sensing paper, also referred to as pressure-sensitive paper) to generate an indentation pattern, and use vision to identify the distribution of the indentation pattern to determine whether the flatness of the manufacturing element has shifted. However, the above judgments are usually subjective and have no fixed standards. Therefore, how to provide a detection step and detection method with fixed and/or effective detection standards for manufacturing elements is one of the research focuses of those skilled in the art.

### SUMMARY

A manufacturing method of an electronic device having a detection step, in which the detection step may provide a fixed and/or effective detection standard, is provided in the disclosure.

According to an embodiment of the disclosure, a manufacturing method of an electronic device includes a detection step. The detection step is used to detect a pressure distribution of a manufacturing element. The detection step includes the following steps. A detection element is provided. The manufacturing element is pressed on a detection element to generate multiple indentation patterns. The indentation patterns are converted into multiple image data. An image feature value is calculated by using the image data. A relationship between the image feature value and a threshold is compared and a comparison result is generated.

According to an embodiment of the disclosure, a manufacturing method of an electronic device includes a detection step for detecting a manufacturing element. The detection step includes the following operation. The manufacturing element is pressed on a detection element to generate multiple indentation patterns, and the indentation patterns are converted into multiple image data to calculate a first image feature value of the manufacturing element corresponding to a first work count. A feature value trend is generated according to the first image feature value corresponding to a first work count and multiple image feature values corresponding to different work counts that are less than the first work count. Multiple historical feature value trends are compared to find the reference historical feature value trend that is most similar to the feature value trend. The work count of unqualified work that is potentially generated by the manufacturing element is calculated by using the reference historical feature value trend.

According to an embodiment of the disclosure, a manufacturing method of an electronic device includes a detection step for detecting a manufacturing equipment. The detection step includes the following operation. Multiple manufacturing equipment are provided. Each of the manufacturing equipment has multiple historical feature value trends, and multiple changing trends of the manufacturing equipment are generated by using multiple feature values corresponding to the same evaluated work count among the historical feature value trends of each of the manufacturing equipment. A threshold is generated by using the changing trends. The changing trends and the threshold are compared and a comparison result is generated.

Based on the above, the detection step converts the pressure distribution of the manufacturing element into an image feature value. The detection step compares a relationship between the image feature value and a threshold and generates a comparison result. Therefore, the detection step provides a fixed and/or effective detection standard to determine the pressure distribution of the manufacturing element without relying on the vision of the inspector to subjectively determine the pressure distribution of the manufacturing element. In addition, the detection step in the manufacturing method of the electronic device is also used to detect the state of the manufacturing equipment and manufacturing element and provide early warning.

### BRIEF DESCRIPTION OF THE DRAWINGS

FIG. 1 is a flowchart of a manufacturing method of an electronic device according to an embodiment of the disclosure.

FIG. 2 is a schematic diagram of a manufacturing element, a detection element, and a detection device according to an embodiment of the disclosure.

FIG. 3 is a flowchart of a detection step according to an embodiment of the disclosure.

FIG. 4A is a schematic diagram of a detection element according to an embodiment of the disclosure.

FIG. 4B is a schematic diagram of image data generation according to an embodiment of the disclosure.

FIG. 5 is a flowchart of a manufacturing method of an electronic device according to an embodiment of the disclosure.

FIG. 6 is a flowchart of a threshold establishing step according to an embodiment of the disclosure.

FIG. 7 is a schematic diagram of a detection device according to an embodiment of the disclosure.

FIG. 8 is a schematic diagram of a detection device according to an embodiment of the disclosure.

FIG. 9 is a schematic diagram of the application field of detection according to an embodiment of the disclosure.

FIG. 10 is a flowchart of a manufacturing method of an electronic device according to an embodiment of the disclosure.

FIG. 11 is a schematic diagram of a manufacturing equipment, a detection element, and a detection device according to an embodiment of the disclosure.

FIG. 12 is a schematic diagram of a record table according to an embodiment of the disclosure.

FIG. 13 is a schematic diagram of historical feature value trends and a feature value trend according to an embodiment of the disclosure.

FIG. 14 is a flowchart of a manufacturing method of an electronic device according to an embodiment of the disclosure.

FIG. 15 is a schematic diagram of multiple historical feature value trends and a changing trend according to an embodiment of the disclosure.

FIG. 16 is a distribution diagram according to an embodiment of the disclosure.

### DETAILED DESCRIPTION OF DISCLOSED EMBODIMENTS

The disclosure may be understood by referring to the following detailed description in conjunction with the accompanying drawings as described below. It should be noted that, for purposes of clarity and easy understanding by readers, each drawing of the disclosure depicts a part of an electronic device, and some components in each drawing may not be drawn to scale. In addition, the number and size of each device depicted in the drawings are illustrative only and not intended to limit the scope of the disclosure.

Certain terms are used throughout the description and claims below to refer to specific components. It should be understood by those skilled in the art, manufacturers of electronic equipment may refer to components by different names. The disclosure does not intend to distinguish between components that differ in name but not function. In the following description and in the claims, the terms “comprising”, “including”, and “having” are used in an open-ended manner, and should therefore be construed to mean “including but not limited to . . . ”, therefore, when the terms “comprising”, “including”, and/or “having” are used in the description, it indicates the existence of corresponding features, regions, steps, operations, and/or components, but not limited to the existence of one or more corresponding features, regions, steps, operation, and/or components.

It should be understood that when a component is referred to as being “coupled to”, “electrically connected to”, or “conducted to” another component, the component may be directly connected to another component and an electrical connection may be established directly, or there may be an intermediate component between these components for a relay electrical connection (indirect electrical connection). In contrast, when a component is referred to as being “directly coupled to,” “directly connected to”, or “directly electrically connected to” another component, there are no intermediate components present.

When an element is referred to as being “on” or “connected to” another element, it may be directly on or directly connected to this other element, or there may be an intervening element in between. In contrast, when an element is referred to as being “directly on” or “directly connected to” another element, there are no intervening elements present.

Although terms such as first, second, third, etc. may be used to describe various constituent components, such constituent components not limited by these terms. The terms are only used to distinguish a constituent component from other constituent components in the specification. Claims may not use the same terms, but may use the terms first, second, third, etc. with respect to the required order of the components. Therefore, in the following description, the first constituent component may be the second constituent component in the claims.

The electronic device of the disclosure may include a display device, an antenna device, a sensing device, a light-emitting device, a touch display device, a curved display device, or a free shape display, but not limited thereto. The electronic device may include a bendable or flexible electronic device. The electronic device may, for example, comprise liquid crystal, light-emitting diode, quantum dot (QD), fluorescence, phosphor, other suitable display materials, or a combination of the materials thereof, but not limited thereto. The light-emitting diode may include, for example, an organic light-emitting diode (OLED), a mini light-emitting diode (mini LED), a micro light-emitting diode (micro LED), or a quantum dot light-emitting diode (quantum dot LED, which may include QLED, QDLED), or other suitable materials, or a combination thereof, but not limited thereto. The display device may include, for example, but not limited to, a spliced display device. The antenna device may be, for example, a liquid crystal antenna, but not limited thereto. The antenna device may, for example, include an antenna splicing device, but not limited thereto. It should be noted that, the electronic device may be any arrangement and combination of the foregoing, but not limited thereto. In addition, the shape of the electronic device may be rectangular, circular, polygonal, a shape with curved edges, or other suitable shapes. The electronic device may have peripheral systems such as a driving system, a control system, a light source system, etc. to support a display device, an antenna device, or a spliced device, but the disclosure is not limited thereto. The sensing device may include a camera, an infrared sensor, or a fingerprint sensor, etc., and the disclosure is not limited thereto. In some embodiments, the sensing device may further include a flash, an infrared (IR) light source, other sensors, electronic components, or a combination thereof, but not limited thereto.

In the disclosure, the embodiments use “pixel” or “pixel unit” as a unit for describing a specific area including at least one functional circuit for at least one specific function. The area of the ‘pixels’ depends on the unit configured to provide a specific function, adjacent pixels may share the same parts or wires, but may also contain specific parts within themselves. For example, adjacent pixels may share the same scan line or the same data line, but a pixel may also have its own transistors or capacitors.

It should be noted that technical features in different embodiments described below may be replaced, reorganized or mixed with each other to form another embodiment without departing from the spirit of the disclosure.

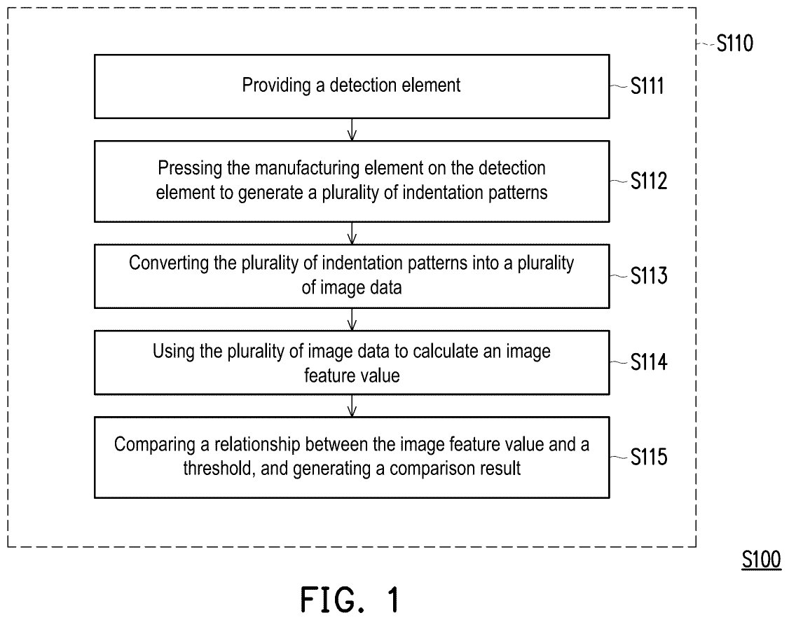

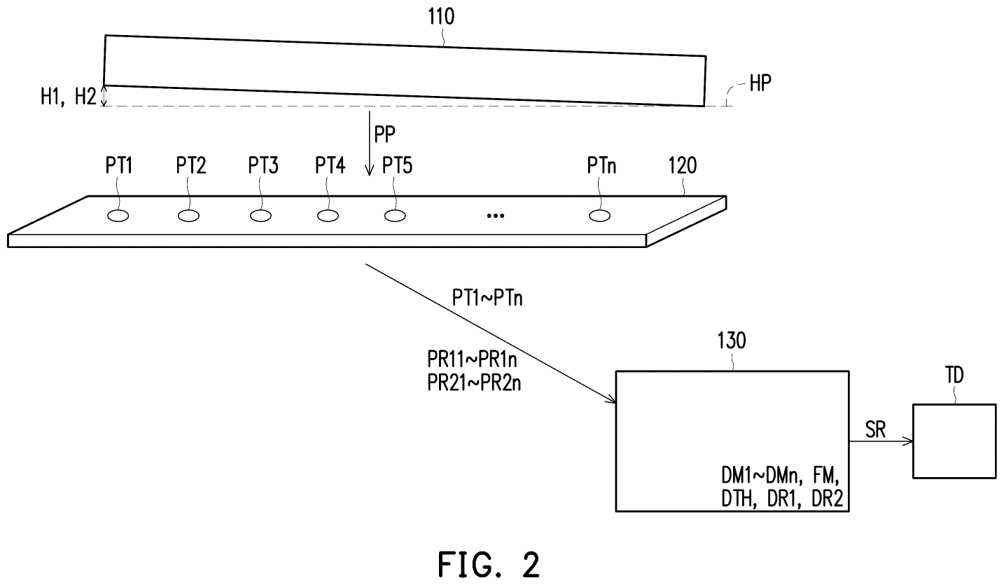

Referring to FIG. 1 and FIG. 2 at the same time, FIG. 1 is a flowchart of a manufacturing method of an electronic device according to an embodiment of the disclosure. FIG. 2 is a schematic diagram of a manufacturing element, a detection element, and a detection device according to an embodiment of the disclosure. In this embodiment, the electronic device manufacturing method S100 is used to manufacture the electronic device by using the manufacturing element 110 to execute processing operation. In one embodiment, the electronic device manufacturing method S100 may be used to manufacture components, semi-finished products or finished products in an electronic device, such as circuit boards in the electronic device, but not limited thereto. For example, the manufacturing element 110 may be a bonding tool, but the disclosure is not limited thereto. In this embodiment, the electronic device manufacturing method S100 includes a detection step S110. The detection step S110 may detect the state of the manufacturing element 110. Furthermore, the detection step S110 is used to detect the pressure distribution of the manufacturing element 110.

In this embodiment, the detection step S110 includes steps S111 to S115. In step S111, the detection element 120 is provided. In step S112, the manufacturing element 110 is operated to be pressed on the detection element 120 to generate indentation patterns PT1 to PTn. The indentation patterns PT1 to PTn are related to the pressure distribution applied by the manufacturing element 110 on the detection element 120. In this embodiment, the detection element 120 may be a pressure sensing element, but not limited thereto. The detection element 120 may be, for example, pressure sensing paper, but not limited thereto. The manufacturing element 110 provides a pressing pressure PP to the detection element 120 in step S112. Therefore, in response to the pressing pressure PP, the detection element 120 generates indentation patterns PT1 to PTn.

In this embodiment, steps S113 to S115 may be, for example, executed by the detection device 130. In step S113, the indentation patterns PT1 to PTn may be captured as images through the detection device 130, and the indentation patterns PT1 to PTn may be converted into image data DM1 to DMn. For example, the image data DM1 is image data converted from the indentation pattern PT1 after being captured as an image by the detection device 130. The image data DM2 is image data converted from the indentation pattern PT2 after being captured as an image by the detection device 130, and so on.

In step S114, the detection device 130 uses the image data DM1 to DMn to calculate an image feature value FM. In step S115, the detection device 130 compares the relationship between the image feature value FM and a threshold DTH and generates a comparison result SR. In one embodiment, the detection device 130 may transmit the comparison result SR to the terminal device TD through wired transmission or wireless transmission to present the comparison result SR, but not limited thereto. In some embodiments, the terminal device TD displays the comparison result SR. The inspector or maintenance personnel determines the comparison result SR through the terminal device TD, and adjusts the manufacturing element 110 based on the comparison result SR until the comparison result SR is qualified. The terminal device TD may be, for example, a screen, a mobile phone, a light signal, a speaker, or other devices that allow the inspector or maintenance personnel to sense the comparison result SR, or a combination thereof, and the disclosure is not limited thereto.

It is worth mentioning here that the detection step S110 converts the indentation patterns PT1 to PTn related to the pressure distribution of the manufacturing element 110 into image data DM1 to DMn, and calculates the image feature value FM by using the image data DM1 to DMn. The detection step S110 compares the relationship between the image feature value FM and the threshold DTH and generates a comparison result SR. In other words, the detection step S110 determines the state of the manufacturing element 110 according to the relationship between the image feature value FM and the threshold DTH. In this way, the detection step S110 provides a fixed detection standard to determine the pressure distribution of the manufacturing element 110 without relying on the vision of the inspector to subjectively determine the pressure distribution of the manufacturing element 110.

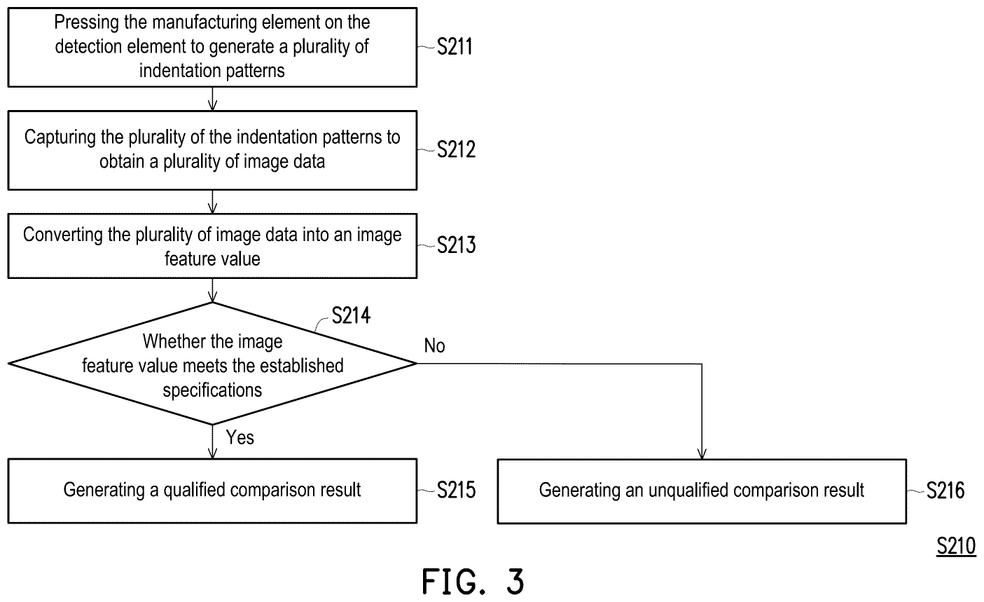

Referring to FIG. 2 and FIG. 3 at the same time, FIG. 3 is a flowchart of a detection step according to an embodiment of the disclosure. In this embodiment, the detection step S210 includes steps S211 to S216. In step S211, the manufacturing element 110 is operated to be pressed on the detection element 120 to generate indentation patterns PT1 to PTn. In step S212, the detection device 130 captures the indentation patterns PT1 to PTn to obtain the image data DM1 to DMn. For example, the detection device 130 may convert the indentation patterns PT1 to PTn into image data DM1 to DMn through an area imaging element (e.g., frame camera). The detection device 130 may also first obtain images of the indentation patterns PT1 to PTn through the area imaging element and then convert the images into image data DM1 to DMn. For another example, the detection device 130 may convert the indentation patterns PT1 to PTn into image data DM1 to DMn through a line scan imaging element. The detection device 130 may also first obtain images of the indentation patterns PT1 to PTn through the line scan imaging element and then convert the images into image data DM1 to DMn.

In step S213, the detection device 130 converts the image data DM1 to DMn into an image feature value FM. In step S214, the detection device 130 determines whether the image feature value FM meets the established specification. When the image feature value FM meets the established specification, the detection device 130 generates a qualified comparison result SR1 in step S215. On the other hand, when the image feature value FM does not meet the established specification, the detection device 130 generates an unqualified comparison result SR2 in step S216.

For example, the image feature value FM is related to the actual tilt angle of the manufacturing element 110. The threshold DTH is the upper limit of the tilt angle in the established specification. In step S214, the detection device 130 compares the image feature value FM and the threshold DTH. When the image feature value FM is less than or equal to the threshold DTH, it means that the actual tilt angle of the manufacturing element 110 is less than or equal to the upper limit of the tilt angle in the established specification. In other words, the actual tilt angle of the manufacturing element 110 is still within the established specification. Therefore, the detection device 130 generates a qualified comparison result SR1 in step S215. On the other hand, when the image feature value FM is greater than the threshold DTH, it means that the actual tilt angle of the manufacturing element 110 is greater than the upper limit of the tilt angle in the established specification. In other words, the actual tilt angle of the manufacturing element 110 exceeds the established specification, and the detection device 130 generates an unqualified comparison result SR2 in step S216.

In this example, the detection device 130 stores the image data DM1 to DMn. After step S216, the inspector may adjust the tilt angle of the manufacturing element 110 based on the unqualified comparison result SR2. Subsequently, the detection step S210 may be executed again to confirm the adjusted result of the manufacturing element 110.

The following provides examples to illustrate the generation methods of image data and image feature value FM.

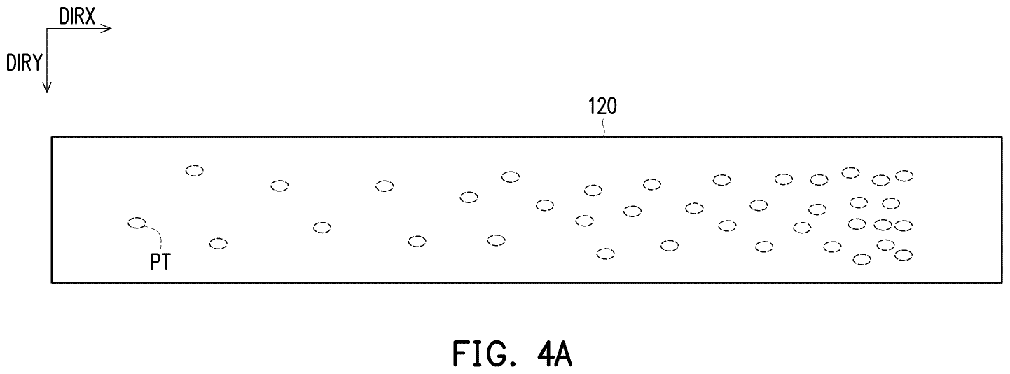

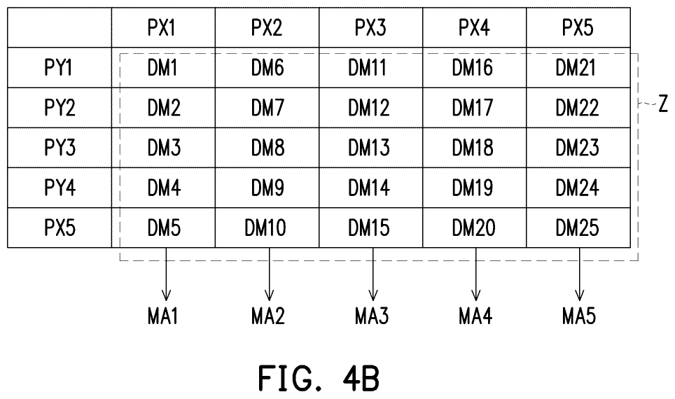

Referring to FIG. 2, FIG. 4A, and FIG. 4B at the same time, FIG. 4A is a schematic diagram of a detection element according to an embodiment of the disclosure. FIG. 4B is a schematic diagram of image data generation according to an embodiment of the disclosure. In this embodiment, the manufacturing element 110 is operated to be pressed on the detection element 120 to generate multiple indentation patterns PT. The detection device 130 may be used to obtain an image of the detection element 120 and convert the image into image data. In this embodiment, the detection device 130 may define five area columns PX1 to PX5 along the direction DIRX and five area rows PY1 to PY5 along the direction DIRY based on the image data, but the disclosure is not limited thereto. Therefore, for example, the detection device 130 defines a total of 25 image areas on the image of the detection element 120, as shown in area Z in FIG. 4B. In this embodiment, the image data DM1 to DM25 in area Z are grayscale values respectively. The image data DM1 is the grayscale value in the intersection area of the area column PX1 and the area row PY1. The image data DM2 is the grayscale value in the intersection area of the area column PX2 and the area row PY1, and so on. In one embodiment, one area column and one area row may correspond to the image data of one pixel in the image, but not limited thereto.

In this embodiment, the areas with fewer or lighter indentations on the detection element 120 have more white areas in the image obtained. When the image of this area is converted into image data, the corresponding grayscale value in this image area is higher. Therefore, the value of the image data is also higher. For example, the indentation amount of the area column PX1 is less than the indentation amount of the area column PX5 or the indentation of the area column PX1 is shallower than the indentation of the area column PX5. Therefore, the image data corresponding to the area column PX1 (i.e., the image data DM1 to DM5) is greater than the image data corresponding to the area column PX5 (i.e., the image data DM21 to DM25).

For example, when the detection device 130 obtains an image of the detection element 120, such as a color image (e.g., an RGB image, the disclosure is not limited thereto), since one pixel includes a red sub-pixel, a green sub-pixel, and a blue sub-pixel, the detection device 130 may convert the image data of red sub-pixel, green sub-pixel, and blue sub-pixel into image data of one pixel by using a calculation method (such as a weight calculation, but the disclosure is not limited thereto).

For example, the amount of area columns is 200. The amount of area rows is 5. Therefore, the detection device 130 obtains image data of 200×50 pixels. The detection device 130 adds the pixels in each column and averages them to obtain the corresponding grayscale value of the corresponding row. Therefore, the detection device 130 generates a total of 200 grayscale values.

Next, the detection device 130 further calculates the image feature value FM.

The detection device 130 calculates the data average value MA1 corresponding to the area column PX1, the data average value MA2 corresponding to the area column PX2, the data average value MA3 corresponding to the area column PX3, the data average value MA4 corresponding to the area column PX4, and the data average value MA5 corresponding to the area column PX5.

For example, the image data DM1 to DM5 are “150”, “152”, “144”, “129”, and “138” respectively. Therefore, the data average value MA1 is “142”. The image data DM6 to DM10 are “150”, “151”, “142”, “145”, and “131” respectively. Therefore, the data average value MA2 is “143”. The image data DM11 to DM15 are “141”, “138”, “135”, “136”, and “93” respectively. Therefore, the data average value MA3 is “128”. The image data DM16 to DM20 are “144”, “143”, “130”, “128”, and “91” respectively. Therefore, the data average value MA4 is “127”. The image data DM21 to DM25 are “131”, “126”, “70”, “69”, and “59” respectively. Therefore, the data average value MA5 is “91”.

In an embodiment, based on the first calculation method, the detection device 130 can, for example, calculate the image feature value FM according to Formula (1). It should be understood that Formula (1) is a slope formula. In other words, the image feature value FM is a slope value. The image feature value FM is the slope value of the data average values MA1 to MA5.

$$F M = \frac{{\sum }_{i = 1}^{N} ( MAi - MAA ) \times ( PXi - PXA )}{{\sum }_{i = 1}^{N} {( MAi - MAA )}^{2}} \qquad Formula ( 1 )$$

Taking this calculation method as an example, “i” is equal to “1” to “5”. Therefore, the detection device 130 calculates the image feature value FM by using the data average values MA1 to MA5 and the values of the area columns PX1 to PX5. In Formula (1), “PXA” is the average value of the values of the area columns PX1 to PX5, as shown in Formula (2). The values of area columns PX1 to PX5 are “1”, “2”, “3”, “4”, and “5” respectively, but this disclosure is not limited thereto. Therefore, “PXA” equals “3”.

$$PXA = \frac{{\sum }_{i = 1}^{N} PXi}{N} \qquad Formula ( 2 )$$

In Formula (1), “MAA” is the average of the data average values MA1 to MA5, as shown in Formula (3). Based on Formula (3), “MAA” is equal to “126.2”. Therefore, based on Formula (1), the image feature value FM is approximately equal to “−11.8”.

$$MAA = \frac{{\sum }_{i = 1}^{N} MAi}{N} \qquad Formula ( 3 )$$

In this calculation method, the image feature value FM is related to the fitting slope of the data average values MA1 to MA5 in the area columns PX1 to PX5. When the absolute value of the image feature value FM increases, it means that the actual tilt angle of the manufacturing element 110 relative to the horizontal plane HP increases. When the absolute value of the image feature value FM decreases, it means that the actual tilt angle of the manufacturing element 110 relative to the horizontal plane HP decreases. When the image feature value FM is a negative value, it means that the pressing pressure PP of the manufacturing element 110 gradually increases along the direction DIRX. When the image feature value FM is a positive value, it means that the pressing pressure PP of the manufacturing element 110 gradually decreases along the direction DIRX.

In another embodiment, based on the second calculation method, the detection device 130 may, for example, calculate the image feature value FM according to Formula (4). It should be understood that Formula (4) is the standard deviation formula. In other words, the image feature value FM is a standard deviation value. The image feature value FM is the standard deviation value of the data average values MA1 to MA5.

$$F M = \sqrt{\frac{1}{N} {\sum }_{i = 1}^{N} {( MAi - MAA )}^{2}} \qquad Formula ( 4 )$$

In this calculation method, “N” equals “5”. Based on Formula (3), “MAA” is equal to “126.2”. Therefore, based on Formula (4), the image feature value FM is approximately equal to “18.84”. In this calculation method, the image feature value FM is the standard deviation value of the data average values MA1 to MA5. When the image feature value FM increases, it means that the actual tilt angle of the manufacturing element 110 relative to the horizontal plane HP increases. When the image feature value FM decreases, it means that the actual tilt angle of the manufacturing element 110 relative to the horizontal plane HP decreases.

In another embodiment, based on the third calculation method, the detection device 130 may, for example, calculate the image feature value FM according to Formula (3). In other words, the image feature value FM is the average of the data average values MA1 to MA5 (i.e., “MAA”). When the image feature value FM decreases, it means that the surface of the manufacturing element 110 is uneven and the pressure distribution is uneven. For example, when the image feature value FM decreases, it means that a chip may occur on the surface of the manufacturing element 110.

In another embodiment, based on the fourth calculation method, the detection device 130 may use quartiles to calculate the image feature value FM. First, the detection device 130 arranges the data average values MA1 to MA5 in ascending order according to the values of the data average values MA1 to MA5. Therefore, the detection device 130 arranges the data average values MA1 to MA5 in order as “MA5, MA4, MA3, MA1, MA2” (i.e., “91”, “127”, “128”, “142”, “143”).

The detection device 130 obtains the first quartile and the third quartile. The first quartile is the 25th percentile of numbers in ascending order. The third quartile is the 75th percentile of numbers in ascending order. The detection device 130 obtains the position of the first quartile based on “P1=(N+1)×25%” and obtains the position of the third quartile based on “P3=(N+1)×75%”. In this calculation method, “N” equals “5”. “P1” is equal to “1.5”. “P3” is equal to “4.5”. Therefore, the detection device 130 determines based on “P1” that the first quartile is between the data average value MA5 and the data average value MA4, and determines based on “P3” that the third quartile is between the data average value MA2 and the data average value MA1. As shown in Formulas (5) and (6), the detection device 130 may obtain that the first quartile Q1 is equal to “109” based on the interpolation calculation of “P1”. The detection device 130 may obtain that the third quartile Q3 is equal to “142.5” based on the interpolation calculation of “P3”.

$$Q 1 = M A 5 + ( MA 4 - MA 5 ) \times ( P 1 - 1 ) \qquad Formula ( 5 )$$

$$Q 3 = M A 1 + ( MA 2 - MA 1 ) \times ( P 3 - 4 ) \qquad Formula ( 6 )$$

The detection device 130 may calculate the image feature value FM based on the difference between the third quartile Q3 and the first quartile Q1. When the image feature value FM increases, it means that the actual tilt angle of the manufacturing element 110 relative to the horizontal plane HP increases. When the image feature value FM decreases, it means that the actual tilt angle of the manufacturing element 110 relative to the horizontal plane HP decreases.

In another embodiment, based on the fifth calculation method, the detection device 130 may, for example, calculate the image feature value FM according to Formula (7). It should be understood that Formula (7) is the mean absolute deviation (MAD) formula. In other words, the image feature value FM is the MAD value. The image feature value FM is the MAD value of the data average values MA1 to MA5.

$$F M = \frac{{\sum }_{i = 1}^{N} \vert ( MAi - MAA ) \vert}{N} \qquad Formula ( 7 )$$

In this calculation method, “N” equals “5”. Based on Formula (3), “MAA” is equal to “126.2”. Therefore, based on Formula (7), the image feature value FM is approximately equal to “14.24”. When the image feature value FM increases, it means that the actual tilt angle of the manufacturing element 110 relative to the horizontal plane HP increases. When the image feature value FM decreases, it means that the actual tilt angle of the manufacturing element 110 relative to the horizontal plane HP decreases.

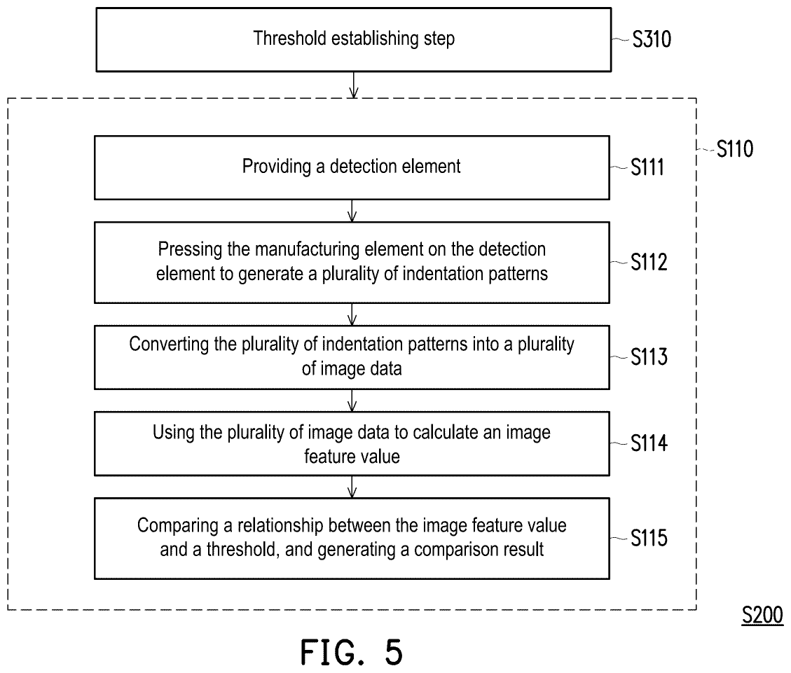

Referring to FIG. 2 and FIG. 5 at the same time, FIG. 5 is a flowchart of a manufacturing method of an electronic device according to an embodiment of the disclosure. In this embodiment, the electronic device manufacturing method S200 includes a threshold establishing step S310 and a detection step S110. The detection step S110 has been clearly explained in the multiple embodiments of FIG. 1 to FIG. 3 and are not repeated herein. In this embodiment, the threshold establishing step S310 is earlier than the detection step S110. The threshold establishing step S310 is used to establish the threshold DTH.

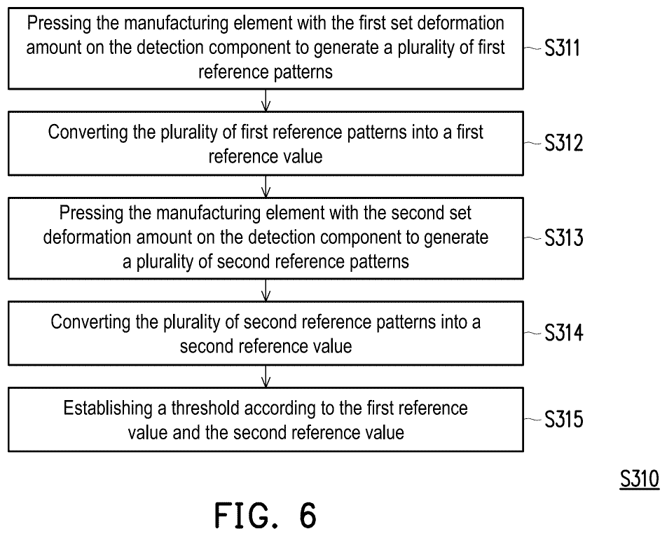

Referring to FIG. 2 and FIG. 6 at the same time, FIG. 6 is a flowchart of a threshold establishing step according to an embodiment of the disclosure. In this embodiment, the threshold establishing step S310 includes steps S311 to S315. In step S311, the manufacturing element 110 with the first set deformation amount (i.e., having the first height difference H1) is operated to be pressed on the detection element 120 to generate the first reference patterns PR11 to PR1n. In this embodiment, multiple set deformation amounts of the manufacturing element 110 are set. The set deformation amount is, for example, the tilt angle of the manufacturing element 110 relative to the horizontal plane HP. In this embodiment, the height difference between the two terminals of the manufacturing element 110 may be adjusted to determine the set deformation amount of the manufacturing element 110. The height difference between the two terminals of the manufacturing element 110 may be adjusted to the first height difference H1 to determine the first set deformation amount of the manufacturing element 110. The height difference between the two terminals of the manufacturing element 110 may be adjusted to the second height difference H2 to determine the second set deformation amount of the manufacturing element 110, and so on.

For example, the inspector may measure the height at the center point of the manufacturing element 110 by using a measuring tool (e.g., a dial indicator) and reset the height at the center point of the manufacturing element 110 to zero. The inspector may measure the current deformation amount (i.e., tilt angle) of the manufacturing element 110 by using the measuring tool. Next, the inspector adjusts the manufacturing element 110 from the current deformation amount to the set deformation amount.

For example, the first height difference H1 corresponding to the first set deformation amount is, for example, 10 micrometers (μm). The second height difference H2 corresponding to the second set deformation amount is, for example, 20 micrometers. The height difference corresponding to the third set deformation amount is, for example, 30 micrometers, and so on.

In step S312, the detection device 130 converts the first reference patterns PR11 to PR1n into the first reference value DR1. In step S312, the detection device 130 captures the first reference patterns PR11 to PR1n, converts the first reference patterns PR11 to PR1n into multiple first reference pattern data, and calculates the first reference value DR1 according to the first reference pattern data. The first reference value DR1 corresponds to the first set deformation amount.

In this embodiment, the first reference data are gray scale values respectively. The calculation method of the first reference value DR1 is similar to the calculation method of the image feature value FM. For example, the detection device 130 calculates the image feature value FM based on the above-mentioned first calculation method. The detection device 130 also calculates the first reference value DR1 based on the first calculation method. For example, the detection device 130 calculates the image feature value FM based on the above-mentioned second calculation method. The detection device 130 also calculates the first reference value DR1 based on the second calculation method, and so on.

In step S313, the manufacturing element 110 with the second set deformation amount (i.e., having the second height difference H2) is operated to be pressed on the detection element 120 to generate the second reference patterns PR21 to PR2n. In step S314, the detection device 130 converts the second reference patterns PR21 to PR2n into the second reference value DR2. In step S314, the detection device 130 captures the second reference patterns PR21 to PR2n, converts the second reference patterns PR21 to PR2n into multiple second reference pattern data, and calculate the second reference value DR2 according to the second reference pattern data. The second reference value DR2 corresponds to the second set deformation amount.

In this embodiment, the second reference data are gray scale values respectively. The calculation method of the second reference value DR2 is similar to the calculation method of the image feature value FM. For example, the detection device 130 calculates the image feature value FM based on the above-mentioned first calculation method. The detection device 130 also calculates the second reference value DR2 based on the first calculation method. For example, the detection device 130 calculates the image feature value FM based on the above-mentioned second calculation method. The detection device 130 also calculates the second reference value DR2 based on the second calculation method, and so on.

In step S315, the detection device 130 establishes the threshold DTH based on the first reference value DR1 and the second reference value DR2. This embodiment uses two reference values as an example, but the disclosure is not limited thereto. In some embodiments, the detection device 130 establishes the threshold DTH according to at least three reference values.

In this embodiment, if the manufacturing element 110, for example, allows the first set deformation amount but does not allow the second set deformation amount during the manufacturing process, the detection device 130 may establish the threshold DTH according to the first reference value DR1 and the second reference value DR2.

For example, based on the first calculation method or the second calculation method, the detection device 130 may obtain the threshold DTH according to the average of the first reference value DR1 and the second reference value DR2. The detection device 130 compares the relationship between the threshold DTH and the image feature value FM generated based on the first calculation method or the second calculation method and generates a comparison result SR.

In one embodiment, for example, based on the third calculation method, the first reference value DR1 is the minimum value among all reference values. The second reference value DR2 is the median among all reference values. The detection device 130 subtracts the first reference value DR1 from the second reference value DR2 to generate a difference and divides the difference by 2 to generate a proportional value. Next, the detection device 130 multiplies the proportional value by the first reference value DR1 to obtain a product value, and adds the product value to the first reference value DR1 to generate the threshold DTH. The detection device 130 compares the relationship between the threshold DTH and the image feature value FM generated based on the third calculation method and generates a comparison result SR.

In one embodiment, for example, based on the fourth calculation method, the first reference value DR1 is the smallest quartile among all reference values. The second reference value DR2 is the largest quartile among all reference values. The detection device 130 subtracts the first reference value DR1 from the second reference value DR2 to generate a difference and divides the difference by 2 to generate a proportional value. Next, the detection device 130 divides the first reference value DR1 by the proportional value to obtain a quotient value, and adds the quotient value to the first reference value DR1 to generate the threshold DTH. The detection device 130 compares the relationship between the threshold DTH and the image feature value FM generated based on the fourth calculation method and generates a comparison result SR.

In one embodiment, for example, based on the fifth calculation method, the first reference value DR1 is the minimum value among all reference values. The second reference value DR2 is the maximum value among all reference values. The third reference value is the median among all reference values. The detection device 130 first obtains the average of the sum of the first reference value DR1 and the second reference value DR2. Next, the detection device 130 divides the average value by the third reference value to generate a first quotient value, divides the first reference value DR1 by the first quotient value to generate a second quotient value, and adds the second quotient value to the first reference value DR1 to generate the threshold DTH. The detection device 130 compares the relationship between the threshold DTH and the image feature value FM generated based on the fifth calculation method and generates a comparison result SR.

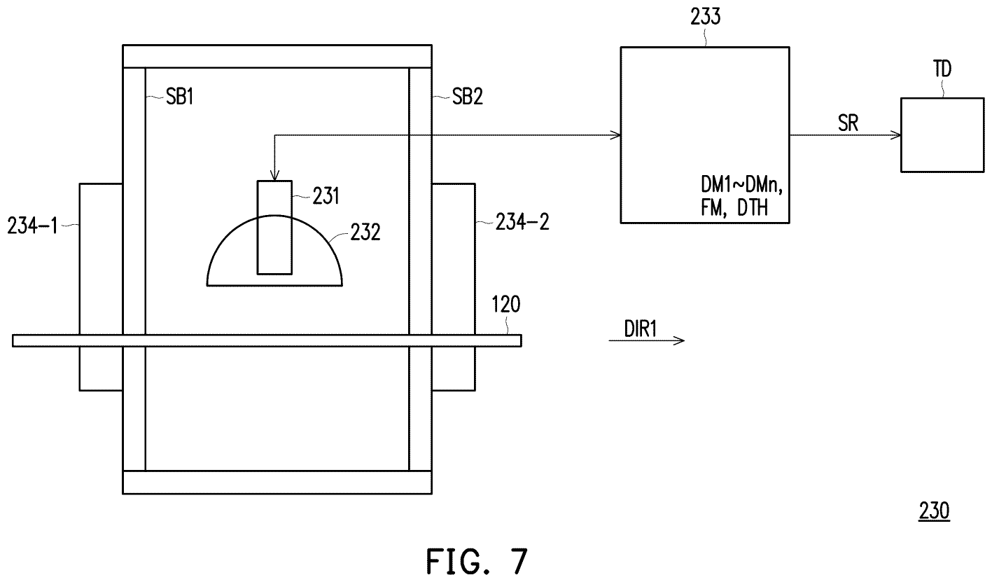

Referring to FIG. 7, FIG. 7 is a schematic diagram of a detection device according to an embodiment of the disclosure. In this embodiment, the detection device 230 includes an image capturing device 231, a light-emitting device 232, and a computing device 233. The light-emitting device 232 provides a light source to the surface of the detection element 120. The light source may be plane light, but not limited to thereto. The computing device 233 controls the image capturing device 231 to capture the indentation pattern (not shown) on the surface of the detection element 120, and convert the indentation pattern into image data DM1 to DMn. The computing device 233 calculates the image feature value FM by using the image data DM1 to DMn.

In this embodiment, the computing device 233 may be an electronic device with computing capabilities, such as a server, a desktop computer, a laptop, a tablet, a smartphone, etc., but not limited thereto.

In this embodiment, the detection device 230 further includes side panels SB1 and SB2 to provide the image capturing device 231 with an environment that facilitates image capturing. In one embodiment, the detection device 230 further includes a fixing element 234-1 and a fixing element 234-2. The fixing element 234-1 may be disposed adjacent to the side panel SB1. The fixing element 234-2 is disposed adjacent to the side panel SB2. The fixing element 234-1 and the fixing element 234-2 may fix the detection element 120 and provide a tensile force to the detection element 120. Therefore, the fixing element 234-1 and the fixing element 234-2 may make the detection element 120 relatively even, thereby improving the clarity of the image obtained by the image capturing device 231 and reducing the out-of-focus situation of the image.

In some embodiments, the fixing element 234-2 may include a motor, a shock absorber element, and a roller (not shown). The motor may drive the roller, thereby rotating the roller and driving the detection element 120 to move in the direction DIR1. The shock absorber element may be used to reduce vibration that occur when the roller rotates. The fixing element 234-1 may include a shock absorber element and a roller. In these embodiments, since the detection device 230 includes a motor, it is suitable for detecting the detection element 120 with a longer length.

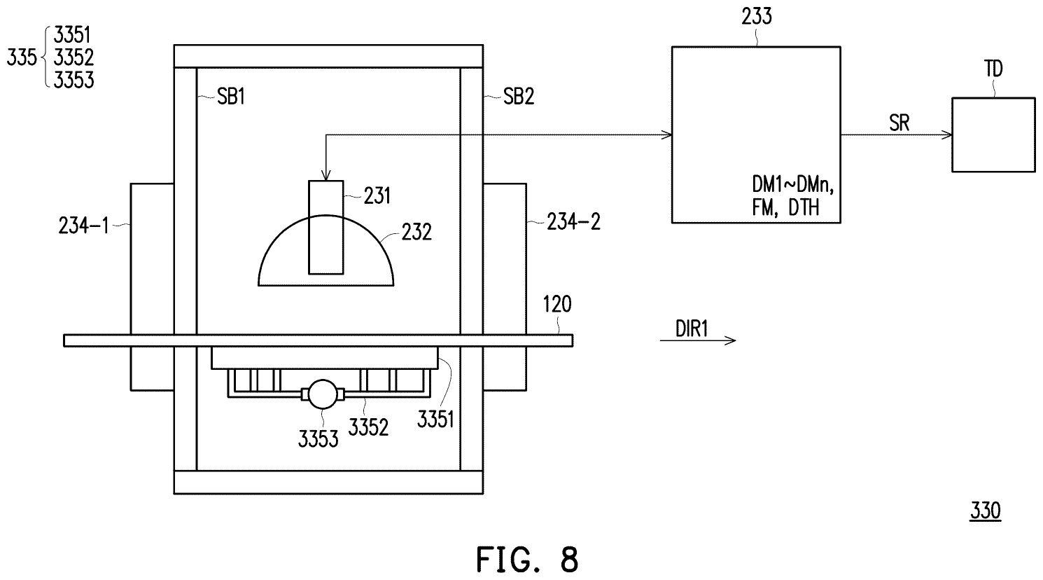

Referring to FIG. 8, FIG. 8 is a schematic diagram of a detection device according to an embodiment of the disclosure. In this embodiment, the detection device 330 includes an image capturing device 231, a light-emitting device 232, a computing device 233 and a flattening device 335. The implementation of the image capturing device 231, the light-emitting device 232 and the computing device 233 has been clearly explained in the embodiment of FIG. 7 and are not repeated herein. The flattening device 335 is, for example, an adsorption device, including an adsorption platform 3351, a conduit 3352, and a suction motor 3353. The suction motor 3353 is connected to the conduit 3352 such that the air pressure in the conduit 3352 is slightly lower than 1 atmosphere. Therefore, the detection element 120 may be evenly fixed on the adsorption platform 3351, thereby improving the clarity of the image obtained by the image capturing device 231 and reducing the out-of-focus situation of the image.

In this embodiment, the detection device 330 further includes side panels SB1 and SB2 to provide the image capturing device 231 with an environment that facilitates image capturing. In one embodiment, the detection device 330 further includes a fixing element 234-1 and a fixing element 234-2. The fixing element 234-1 may be disposed adjacent to the side panel SB1. The fixing element 234-2 is disposed adjacent to the side panel SB2. In some embodiments, the fixing element 234-1 and the fixing element 234-2 may be omitted.

In some embodiments, the fixing element 234-2 may include a motor, a shock absorber element, and a roller (not shown) as described above, which are not repeated herein. The fixing element 234-1 may include a shock absorber element and a roller as described above, which are not repeated herein. In these embodiments, when the detection element 120 is driven, the flattening device 335 may reduce the operating power, for example, stop adsorbing the detection element 120 or slightly increase the air pressure in the conduit 3352, to facilitate the movement of the detection element 120.

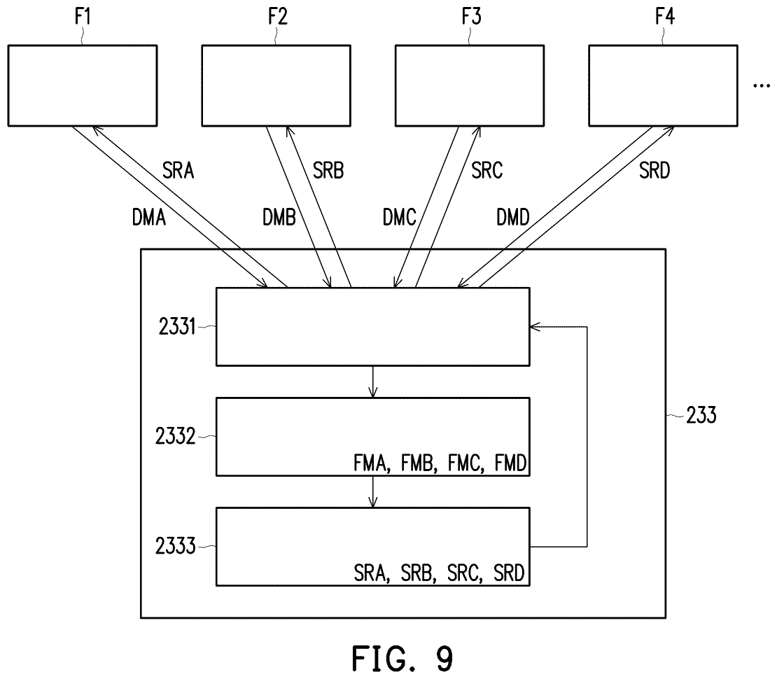

Referring to FIG. 1 and FIG. 9 at the same time, FIG. 9 is a schematic diagram of the application field of detection according to an embodiment of the disclosure. In this embodiment, the technology of the disclosure is at least suitable for detection in a variety of different application fields F1 to F4. The technology of the disclosure is not limited to detecting the tilt angle of the bonding tool. For example, the application field F1 may be a semiconductor packaging application. The application field F2 may be a metal processing application. The application field F3 may be an automotive industry application. The application field F4 may be an aerospace industrial application, but not limited thereto.

The application fields F1 to F4 may correspond to the same or different manufacturers. Manufacturing methods for manufacturing electronic devices all involve processing pressure. The evenness of processing pressure and the accuracy of processing pressure affect the quality of the product.

In this embodiment, manufacturers corresponding to the application fields F1 to F4 may execute steps S111 to S113 respectively. Therefore, the manufacturer corresponding to the application field F1 may obtain the image data group DMA. The image data group DMA includes multiple image data. The manufacturer corresponding to the application field F1 may provide the image data group DMA to the computing device 233 through wireless communication or wired communication. The implementation of steps S111 to S113 has been clearly described in the embodiments of FIG. 1 and FIG. 2, so they are not repeated herein.

The manufacturer corresponding to the application field F2 may obtain the image data group DMB. The image data group DMB includes multiple image data. The image data group DMB is provided to the computing device 233. The manufacturer corresponding to the application field F3 may obtain the image data group DMC. The image data group DMC includes multiple image data. The image data group DMC is provided to the computing device 233. In addition, the manufacturer corresponding to the application field F4 may obtain the image data group DMD. The image data group DMD includes multiple image data. The image data group DMD is provided to the computing device 233.

The computing device 233 includes an input/output interface 2331, a data analysis module 2332, and a comparison module 2333. The input/output interface 2331 receives image data groups DMA to DMD. The data analysis module 2332 calculates the image feature value FMA by using multiple image data in the image data group DMA. The data analysis module 2332 calculates the image feature value FMB by using multiple image data in the image data group DMB. The data analysis module 2332 calculates the image feature value FMC by using multiple image data in the image data group DMC. In addition, the data analysis module 2332 calculates the image feature value FMD by using multiple image data in the image data group DMD. In this embodiment, the data analysis module 2332 may execute step S114 to calculate the image feature values FMA, FMB, FMC, and FMD. The implementation of calculating the image feature values FMA, FMB, FMC, and FMD has been clearly described in the embodiments of FIG. 2, FIG. 4A, and FIG. 4B, so they are not repeated herein.

The comparison module 2333 receives image feature values FMA, FMB, FMC, and FMD. The comparison module 2333 may execute step S115 to generate comparison results SRA, SRB, SRC, and SRD. Specifically, the comparison module 2333 compares the image feature value FMA and the first threshold to generate a comparison result SRA. The comparison module 2333 compares the image feature value FMB and the second threshold to generate a comparison result SRB. The comparison module 2333 compares the image feature value FMC and the third threshold to generate a comparison result SRC. The comparison module 2333 compares the image feature value FMD and the fourth threshold to generate a comparison result SRD.

The comparison module 2333 also provides the comparison results SRA, SRB, SRC, and SRD to the input/output interface 2331. The input/output interface 2331 may provide the comparison result SRA to the manufacturer corresponding to the application field F1, provide the comparison result SRB to the manufacturer corresponding to the application field F2, provide the comparison result SRC to the manufacturer corresponding to the application field F3, and provide the comparison result SRD to the manufacturer corresponding to the application field F4.

Based on the above, the computing device 233 provides a state determination service for the manufacturing elements in the application fields F1 to F4.

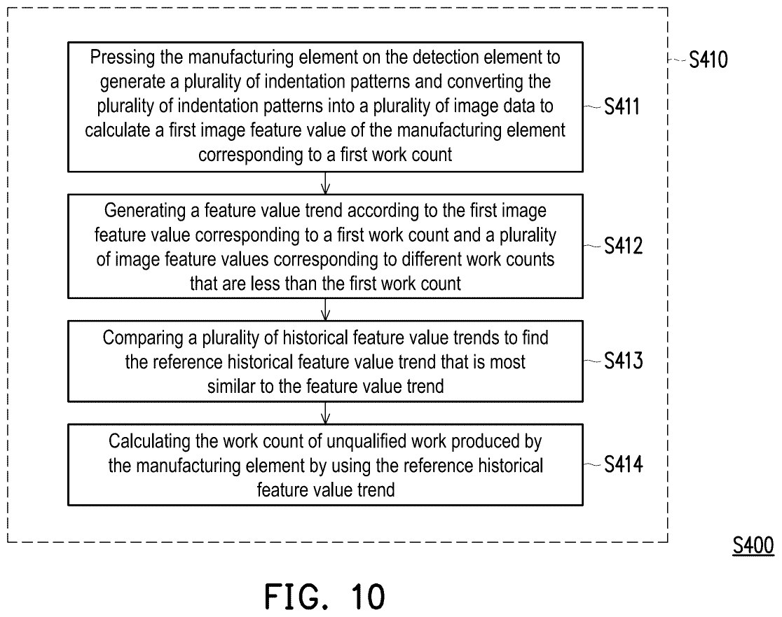

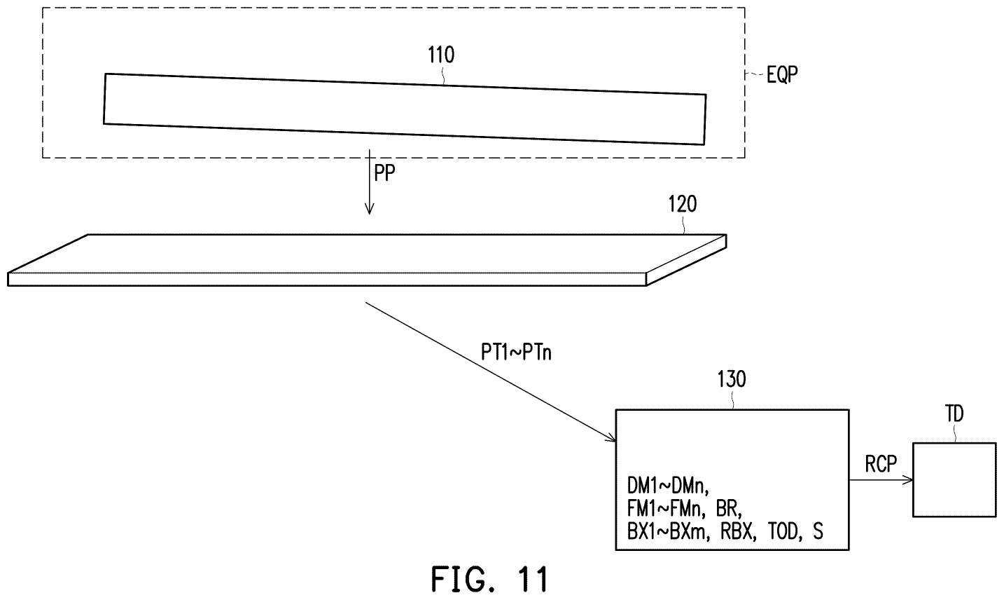

Referring to FIG. 10 and FIG. 11 at the same time, FIG. 10 is a flowchart of a manufacturing method of an electronic device according to an embodiment of the disclosure. FIG. 11 is a schematic diagram of a manufacturing equipment, a detection element, and a detection device according to an embodiment of the disclosure. In this embodiment, the electronic device manufacturing method S400 includes a detection step S410 for detecting the manufacturing element 110. Furthermore, the detection step S410 is used to detect the tilt of the manufacturing element 110 and predict when the manufacturing element 110 may generate an unqualified state. In this embodiment, the detection step S410 includes steps S411 to S415. In step S411, the manufacturing element 110 is operated to be pressed on the detection element 120 to generate indentation patterns PT1 to PTn. The detection device 130 converts the indentation patterns PT1 to PTn into image data DM1 to DMn to calculate the first image feature value FM1 of the manufacturing element 110 corresponding to the first work count.

In step S412, the detection device 130 generates a feature value trend BR according to the first image feature value FM1 corresponding to the first work count and the image feature values FM2 to FMn corresponding to different work counts that are less than the first work count.

In this embodiment, the manufacturing equipment EQP controls the manufacturing element 110 to perform operations and count the operation count to generate a work count. When the manufacturing equipment EQP generates unqualified operations and needs to make adjustments to return to qualified operations, the work count is reset to zero. In one embodiment, when the work count reaches a preset work (e.g., 100 times, the second work count), the detection device 130 detects the manufacturing element 110 and generates an image feature value FM2 corresponding to the work count. When the work count reaches the next preset work count (e.g., 200 times, the third work count), the detection device 130 detects the manufacturing element 110 and generates an image feature value FM3 corresponding to the work count. By the same token, when the work count reaches the n^{th} preset work count (e.g., 900 times, the n^{th} work count), the detection device 130 detects the manufacturing element 110 and generates an image feature value FMn corresponding to the work count. When the work count reaches the first work count (e.g., 1000), the detection device 130 generates the first image feature value FM1 corresponding to the first work count. The value of the second work count to the value of the n^{th} work count are respectively less than the value of the first work count.

Next, in step S412, the detection device 130 generates the feature value trend BR according to the first image feature value FM1 and the image feature values FM2 to FMn.

In step S413, the detection device 130 compares the historical feature value trends BX1 to BXm to find the one most similar to the feature value trend BR as the reference historical feature value trend RBX. The feature value trend BR represents the changing trend of the image feature values FM1 to FMn with different work counts.

In step S414, the detection device 130 calculates the work count of unqualified work generated by the manufacturing element 110 by using the reference historical feature value trend RBX. Taking this embodiment as an example, the detection device 130 may generate the calculation result RCP by using the reference historical feature value trend RBX. The calculation result RCP includes the generated work count of unqualified work of the manufacturing element 110, thereby calculating the time point or time interval of unqualified work that is potentially generated. In addition, the detection device 130 may transmit the calculation result RCP to the terminal device TD through wired transmission or wireless transmission to present the calculation result RCP, but not limited thereto. In some embodiments, the terminal device TD displays the calculation result RCP.

In this embodiment, the maximum work count corresponding to at least one of the historical feature value trends BX1 to BXm is greater than the first work count. The maximum work count corresponding to the reference historical feature value trend RBX is greater than the first work count. Therefore, the reference historical feature value trend RBX may be regarded as the future changing trend of the currently detected manufacturing element 110. The detection device 130 predicts the work count in which the tilt angle of the manufacturing element 110 is greater than the threshold by using the reference historical feature value trend RBX.

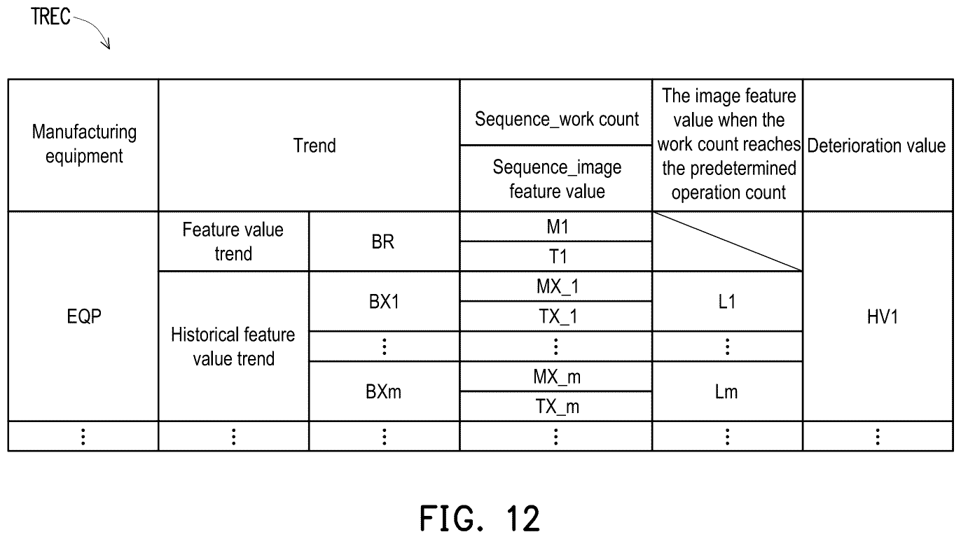

Furthermore, referring to FIG. 10, FIG. 11, and FIG. 12 at the same time, FIG. 12 is a schematic diagram of a record table according to an embodiment of the disclosure. In this embodiment, the record table TREC records image feature values corresponding to manufacturing elements of multiple manufacturing equipment. The record table TREC records at least the historical feature value trends BX1 to BXm and the feature value trend BR of the manufacturing equipment EQP. In this embodiment, it may be stored in the detection device 130.

The feature value trend BR includes the sequences M1 and T1. The sequence T1 includes multiple work counts. For example, the sequence T1 is expressed as “T1={t_{i,1}, t_{i,2}, . . . , t_{i,n}}”. The sequence M1 includes multiple image feature values FM1 to FMn. For example, the sequence M1 is expressed as “M1={FM1, FM2, . . . , FMn}”. In other words, when the work count reaches “t_{i,1}”, the image feature value is equal to the image feature value FM1. When the work count reaches “t_{i,2}”, the image feature value is equal to the image feature value FM2, and so on. The historical feature value trend BX1 includes the sequences MX_1 and TX_1. The sequence TX_1 includes multiple work counts. For example, the sequence TX_1 is expressed as “TX_1={t_{1,1}, t_{1,2}, . . . , t_{1,p}}”. The sequence MX_1 includes multiple image feature values. For example, the sequence MX_1 is expressed as “MX_1={m_{1,1}, m_{1,2}, . . . , m_{1,p}}”. In other words, when the work count reaches “t_{1,1}”, the image feature value is equal to the image feature value “m_{1,1}”. When the work count reaches “t_{1,2}”, the image feature value is equal to the image feature value “m_{1,2}”, and so on.

The historical feature value trend BXm includes the sequences MX_m and TX_m. The sequence TX_m includes multiple work counts. For example, the sequence TX_m is expressed as “TX_m={t_{m,1}, t_{m,2}, . . . , t_{m,q}}”. The sequence MX_m includes multiple image feature values. For example, the sequence MX_m is expressed as “MX_m={m_{m,1}, m_{m,2}, . . . , m_{m,q}}”. In other words, when the work count reaches “t_{m,1}”, the image feature value is equal to the image feature value “m_{m,1}”. When the work count reaches “t_{m,2}”, the image feature value is equal to the image feature value “m_{m,2}”, and so on. The historical feature value trend BX1 and the historical feature value trend BXm are the results of the detection step performed on the manufacturing equipment EQP in different time intervals.

In this embodiment, the feature value trend BR may be generated using linear regression. Similarly, the historical feature value trends BX1 to BXm may respectively be generated using linear regression.

In this embodiment, when the feature value trend BR is generated, the detection device 130 finds the historical feature value trend with a work count greater than the work count of the feature value trend BR from the historical feature value trends BX1 to BXm. For example, both “p” and “q” are greater than “n”. Therefore, the historical feature value trends BX1 and BXm may be selected for comparison with the feature value trend BR. In other words, the historical feature value trends BX1 and BXm are candidate historical feature value trends respectively.

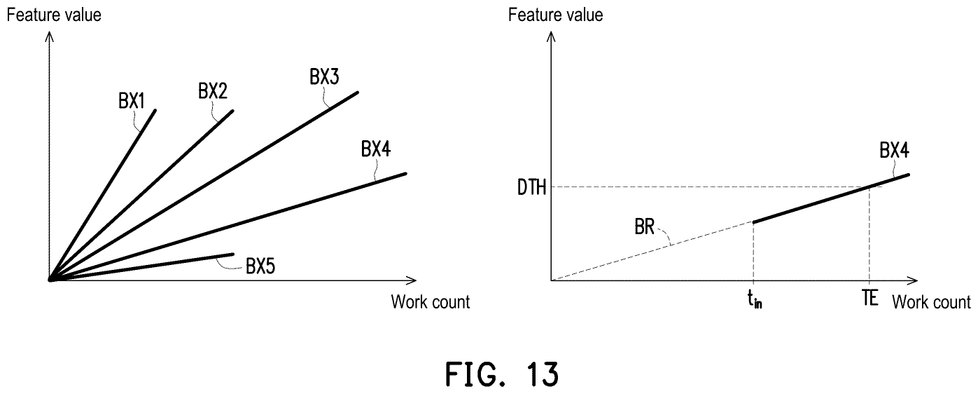

Referring to FIG. 11 and FIG. 13 at the same time, FIG. 13 is a schematic diagram of historical feature value trends and a feature value trend according to an embodiment of the disclosure. FIG. 13 shows the historical feature value trends BX1 to BX5 and the feature value trend BR.

In this embodiment, the work counts of the historical feature value trends BX1, BX2, and BX5 are smaller than the work count of the feature value trend BR. The work counts of the historical feature value trends BX3 and BX4 is greater than the work count of feature value trend BR. Therefore, the historical feature value trends BX3 and BX4 are candidate historical feature value trends respectively. In this embodiment, the detection device 130 determines the historical feature value trend that is most similar to the feature value trend BR from the historical feature value trends BX3 and BX4 as the reference historical feature value trend. In this embodiment, the detection device 130 may compare to find the reference historical feature value trend RBX by using dynamic time warping (DTW). The detection device 130 may perform a DTW operation on the feature value of the feature value trend BR and the feature value of the historical feature value trend BX3 to generate the first warping value, and also perform a DTW operation on the feature value of the feature value trend BR and the feature value of the historical feature value trend BX4 to generate a second warping value. The detection device 130 finds the lowest warping value from the first warping value and the second warping value, and uses the historical feature value trend corresponding to the lowest warping value as the reference historical feature value trend RBX.

In this embodiment, the detection device 130 may also compare to find the reference historical feature value trend RBX by using multiple slopes and multiple intercepts of the historical feature value trends BX3 and BX4. For example, the detection device 130 subtracts the slope of the feature value trend BR from the slope of the historical feature value trend BX3 to generate the first slope difference SS1. The detection device 130 subtracts the intercept of the feature value trend BR from the intercept of the historical feature value trend BX3 to generate a first intercept difference ST1. The detection device 130 multiplies the first slope difference SS1 by the slope weight value W1 to generate a first value. The detection device 130 multiplies the first intercept difference ST1 by the intercept weight value W2 to generate a second value. The detection device 130 adds the absolute value of the first value to the absolute value of the second value to generate the index value D1 of the historical feature value trend BX3. The index value D1 of the historical feature value trend BX3 is shown in Formula (8). As mentioned above, the detection device 130 may also generate the first slope difference SS2 and the first intercept difference ST2 for the historical feature value trend BX4. The detection device 130 multiplies the first slope difference SS2 by the slope weight value W1 to generate a first value. The detection device 130 multiplies the first intercept difference ST2 by the intercept weight value W2 to generate a second value. The detection device 130 adds the absolute value of the first value to the absolute value of the second value to generate the index value D2 of the historical feature value trend BX4. The index value D2 of the historical feature value trend BX4 is shown in Formula (9).

$$D 1 = \vert SS 1 \times W 1 \vert + \vert ST 1 \times W 2 \vert \qquad Formula ( 8 )$$

$$D 2 = \vert SS 2 \times W 1 \vert + \vert ST 2 \times W 2 \vert \qquad Formula ( 9 )$$

In this embodiment, the slope weight value W1 and the intercept weight value W2 have the same order of magnitude, but the disclosure is not limited thereto. In other words, the difference between the slope weight value W1 and the intercept weight value W2 is between 0.1 times and 10 times. Based on actual usage requirements, the slope weight value W1 and the intercept weight value W2 may be adjusted.

The detection device 130 finds the lowest index value from the index values D1 and D2, and uses the historical feature value trend corresponding to the minimum index value as the reference historical feature value trend RBX.

In this embodiment, the detection device 130 may find the historical feature value trend BX4 from the historical feature value trends BX3 and BX4 as the reference historical feature value trend by using the above method. Therefore, the historical feature value trend BX4 may be used as a prediction model for the feature value trend BR. The detection device 130 calculates the work count TE when the feature value reaches the threshold DTH (i.e., unqualified work begins to occur) by using the historical feature value trend BX4. Therefore, the detection device 130 may provide an early warning of the work count for the state of the manufacturing element.

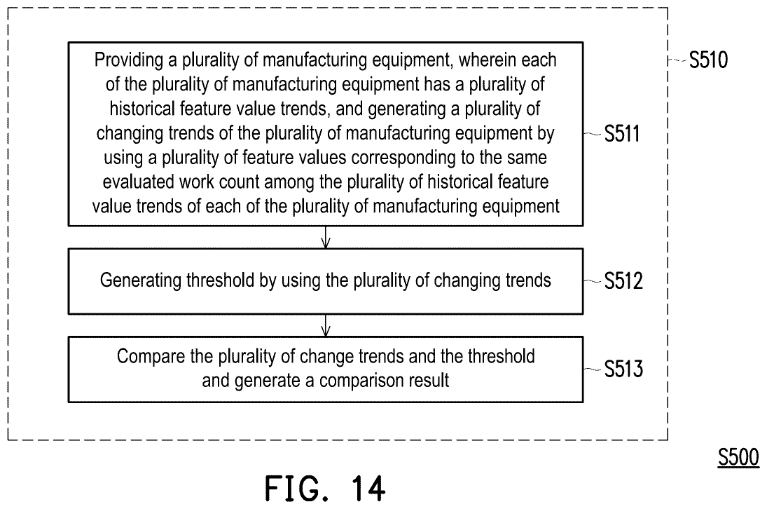

Referring to FIG. 11, FIG. 12, and FIG. 14 at the same time, FIG. 14 is a flowchart of a manufacturing method of an electronic device according to an embodiment of the disclosure. In this embodiment, the electronic device manufacturing method S500 includes a detection step S510 for detecting the manufacturing equipment EQP. In this embodiment, the detection step S510 includes steps S511 to S513. In step S511, multiple manufacturing equipment including the manufacturing equipment EQP are provided. Each of the manufacturing equipment has multiple historical feature value trends (e.g., historical feature value trends BX1 to BXm corresponding to the manufacturing equipment EQP). In step S511, the detection device 130 also generates multiple changing trends of the multiple manufacturing equipment by using multiple feature values corresponding to the same evaluated work count among multiple historical feature value trends of each of the manufacturing equipment.

In step S512, the detection device 130 generates a threshold S by using the changing trends.

In step S513, the detection device 130 compares the changing trends with the threshold S and generates a comparison result SRD.

Taking the manufacturing equipment EQP as an example, in the first time period, the detection device 130 generates the historical feature value trend BX1. In the second time period, the detection device 130 generates the historical feature value trend BX2. In the m^{th} time period, the detection device 130 generates the historical feature value trend BXm. The detection device 130 generates the changing trend HT of the manufacturing equipment EQP according to the historical feature value trends BX1 to BXm of the manufacturing equipment EQP. Different time periods correspond to, for example, different months or week, but not limited thereto.

The detection device 130 generates the changing trend HT of the manufacturing equipment EQP by using multiple feature values L1 to Lm corresponding to the same evaluated work count TOD among the historical feature value trends BX1 to BXm.

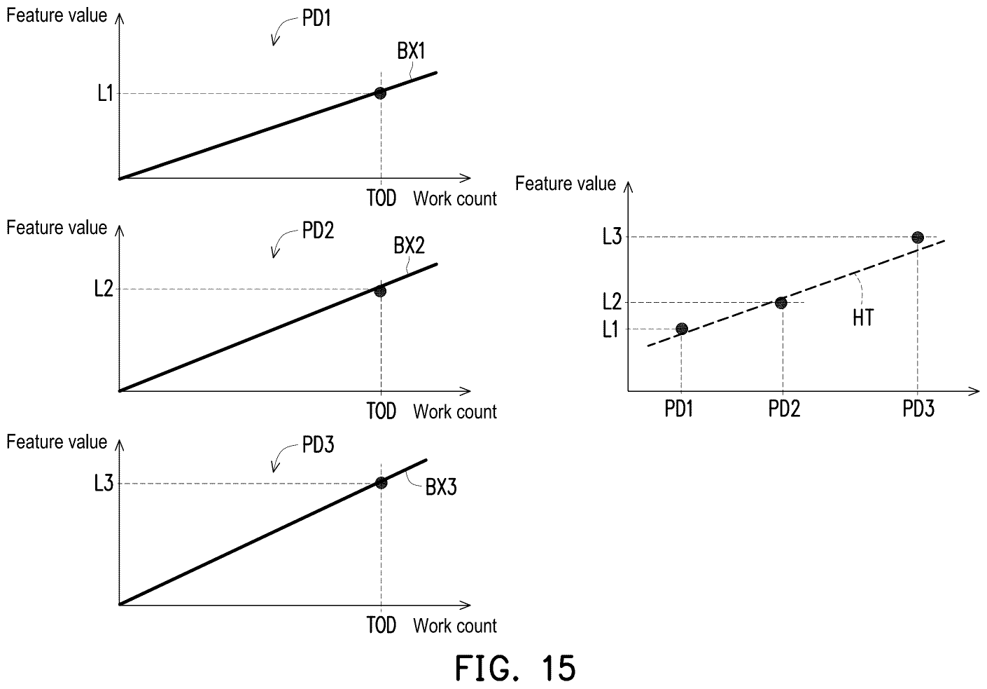

Specifically, please refer to both FIG. 11 and FIG. 15, FIG. 15 is a schematic diagram of multiple historical feature value trends and a changing trend according to an embodiment of the disclosure. In this embodiment, the historical feature value trend BX1 corresponds to the time period PD1. The historical feature value trend BX2 corresponds to the time period PD2. The historical feature value trend BX3 corresponds to the time period PD3. In other words, the historical feature value trend BX1 is the feature value change of the manufacturing element 110 in the time period PD1. The historical feature value trend BX2 is the feature value change of the manufacturing element 110 in the time period PD2. The historical feature value trend BX3 is the feature value change of the manufacturing element 110 in the time period PD3. The time period PD2 is later than the time period PD1. The time period PD3 is later than the time period PD2. In addition, in the range of each time period PD1 to PD3, the manufacturing equipment EQP and the manufacturing element 110 do not perform calibration, maintenance or repair. In other words, the time period range of time periods PD1 to PD3 is the time period range after the manufacturing equipment EQP and the manufacturing element 110 have not been calibrated, maintained or repaired, and after the manufacturing equipment EQP and the manufacturing element 110 perform calibration, maintenance or repair, the time period PD1 will end and the time period PD2 will begin.

In this embodiment, the detection device 130 may determine that the historical feature value trend BX1 has the feature value L1 at the evaluated work count TOD, determine that the historical feature value trend BX2 has the feature value L2 at the evaluated work count TOD, and determine that the historical feature value trend BX3 has the feature value L3 at the evaluated work count TOD. The detection device 130 forms the changing trend HT based on the time periods PD1 to PD3 and the feature values L1 to L3. It should be noted that the changing trend HT may be used as an indicator of the state deterioration of the manufacturing equipment EQP.

Generally speaking, when the state of the manufacturing equipment EQP is extremely stable and good, the historical feature value trends BX1 to BX3 are substantially the same. Therefore, the feature values L1 to L3 does not change significantly. On the contrary, when the state of the manufacturing equipment EQP is extremely unstable, the historical feature value trends BX1 to BX3 change significantly. Therefore, the feature values L1 to L3 also change significantly. For example, if the fixing member used by the manufacturing equipment EQP to fix the manufacturing elements 110 are damaged, loosened or aged, the feature values L1 to L3 may change significantly.

In this embodiment, the detection device 130 obtains the slopes of the multiple changing trends of the multiple manufacturing equipment by using a linear regression method, and uses the slopes of the changing trends as the deterioration values of the manufacturing equipment. Taking the manufacturing equipment EQP as an example, the detection device 130 obtains the slope of the changing trend HT of the manufacturing equipment EQP by using a linear regression method, and uses the slope of the changing trend HT as the deterioration value HV1 of the manufacturing equipment EQP.

Taking the manufacturing equipment EQP as an example again, the detection device 130 provides a threshold S. The detection device 130 compares the threshold S and the deterioration value HV1. When the deterioration value HV1 of the manufacturing equipment EQP is greater than the threshold S, the detection device 130 determines that the state of the manufacturing equipment EQP has deteriorated. The detection device 130 provides an early warning to inform that the manufacturing equipment EQP needs to be calibrated, maintained or repaired. On the other hand, when the deterioration value HV1 of the manufacturing equipment EQP is less than or equal to the threshold S, the detection device 130 determines that the state of the manufacturing equipment EQP has not deteriorated.

In this embodiment, the deterioration value HV1 may be standardized. For example, there are 10 manufacturing equipment in the factory. Therefore, there are 10 deterioration values corresponding to 10 manufacturing equipment in the factory. The detection device 130 receives 10 deterioration values. The deterioration values whose values are greater than or equal to 0 (or referred to as valid deterioration values) are obtained. The deterioration values whose values are less than 0 indicate that the manufacturing equipment EQP has been calibrated, maintained or repaired. Therefore, a deterioration value with a value less than 0 is an invalid deterioration value. The detection device 130 obtains a total of five deterioration values greater than or equal to 0 from the 10 deterioration values, including the deterioration values HV1 to HV5. The standardization constant λ is shown in Formula (10). “N” is the amount of deterioration values greater than or equal to 0.

$$λ = \frac{N}{( HV 1 + HV 2 + HV 3 + HV 4 + HV 5 )} \qquad Formula ( 10 )$$

The detection device 130 multiplies the deterioration value HV1 of the manufacturing equipment EQP by the standardization constant λ to generate a standardized deterioration value HV1′. In addition, the detection device 130 may also respectively multiply the deterioration values HV2 to HV5 of the manufacturing equipment by the standardization constant λ to generate standardized deterioration values HV2′ to HV5′.

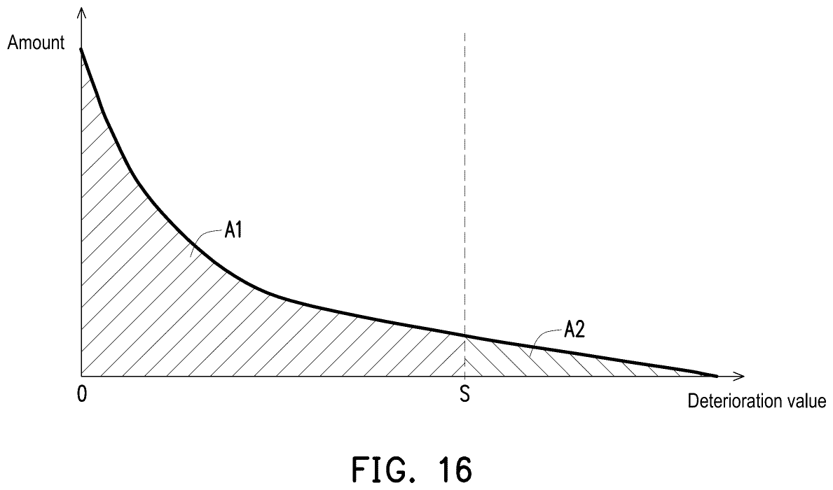

Referring to FIG. 11 and FIG. 16 at the same time, FIG. 16 is a distribution diagram according to an embodiment of the disclosure. FIG. 16 shows the distribution of standardized deterioration values for multiple manufacturing equipment within a factory. Through the maintenance records of multiple manufacturing equipment, the maintenance probability or failure probability of the manufacturing equipment may be determined. Therefore, based on maintenance records, the distribution diagram in FIG. 16 may be divided into areas A1 and A2. The area A1 is the total amount of manufacturing equipment that do not require maintenance or are fault-free. The area A2 is the total amount of manufacturing equipment that require maintenance or are faulty. Therefore, the threshold S is the boundary between areas A1 and A2. In this embodiment, the detection device 130 may calculate the threshold S by using a cumulative distribution function (CDF) and the maintenance probability of the manufacturing equipment EQP. The cumulative distribution function of the distribution diagram in FIG. 16 is, for example, a natural logarithm function with at least the threshold S as a variable. The detection device 130 may obtain the threshold S based on Formula (11).

$$1 - α = 1 - {e}^{λ \times S} \qquad Formula ( 11 )$$

a in Formula (11) is the maintenance probability of the manufacturing equipment EQP and is also the failure probability of the manufacturing equipment in the factory. For example, according to statistics, the maintenance probability a of the manufacturing equipment EQP is 5% (i.e., 0.05). Therefore, the threshold S may be calculated.

In some embodiments, the detection device 130 may sort the deterioration values HV1 to HV5 in descending order. The maintenance personnel confirms whether the manufacturing equipment corresponding to the highest deterioration value has any parts that are aged or damaged. If so, the maintenance personnel confirms whether the manufacturing equipment corresponding to the second highest deterioration value has any parts that are aged or damaged. For example, the deterioration values HV1 to HV5 are sorted in descending order as “HV1>HV2>HV3>HV4>HV5”. The maintenance personnel inspects the manufacturing equipment in order according to the above-mentioned deterioration value ranking. When the parts of the manufacturing equipment with the deterioration value HV3 are not abnormal such as aged or damaged, the threshold S is set to be greater than the deterioration value HV3 and less than the deterioration value HV2. The threshold S may be fine-tuned at regular intervals.

Referring to FIG. 9, FIG. 10, and FIG. 14 at the same time, in this embodiment, the computing device 233 may execute at least one of steps S411 to S414 and steps S511 to S513. Therefore, the computing device 233 provides detection and early warning services for the state of the manufacturing equipment and/or the state of the manufacturing elements for the application fields F1 to F4.

To sum up, the detection step in the manufacturing method of the electronic device may convert the pressure distribution of the manufacturing element into an image feature value. The detection step compares a relationship between the image feature value and a threshold and generates a comparison result. In this way, the detection step provides a fixed and/or effective detection standard to determine the pressure distribution of the manufacturing element without relying on the vision of the inspector to subjectively determine the pressure distribution of the manufacturing element. In addition, the detection step in the manufacturing method of the electronic device is also used to detect the state of the manufacturing equipment and manufacturing element and provide early warning.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A manufacturing method of an electronic device, comprising:
a detection step, used to detect a pressure distribution of a manufacturing element, the detection step comprising:
providing a detection element;
pressing the manufacturing element on the detection element to generate a plurality of indentation patterns;
converting the indentation patterns into a plurality of image data;
calculating an image feature value by using the image data; and
comparing a relationship between the image feature value and a threshold and generating a comparison result.

2. The manufacturing method according to claim 1, wherein converting the indentation patterns into the image data comprises:
converting the indentation patterns into the image data through an area imaging element.

3. The manufacturing method according to claim 1, wherein converting the indentation patterns into the image data comprises:
converting the indentation patterns into the image data through a line scan imaging element.

4. The manufacturing method according to claim 1, wherein the image data are grayscale values respectively.

5. The manufacturing method according to claim 1, wherein the image feature value is a slope value.

6. The manufacturing method according to claim 1, wherein the image feature value is a standard deviation value.

7. The manufacturing method according to claim 1, wherein the image feature value is a mean absolute deviation value.

8. The manufacturing method according to claim 1, wherein the detection step further comprises:
generating a qualified comparison result when the image feature value is less than or equal to the threshold.

9. The manufacturing method according to claim 1, wherein the detection step further comprises:
generating an unqualified comparison result when the image feature value is greater than the threshold.

10. The manufacturing method according to claim 1, further comprising:
a threshold establishing step, the threshold establishing step comprising:
pressing the manufacturing element with a first set deformation amount on the detection element to generate a plurality of first reference patterns;
convert the first reference patterns into a first reference value;
pressing the manufacturing element with a second set deformation amount on the detection element to generate a plurality of second reference patterns;
converting the second reference patterns into a second reference value; and
establishing the threshold according to the first reference value and the second reference value.

11. A manufacturing method of an electronic device, wherein the manufacturing method comprises a detection step for detecting a manufacturing element, wherein the detection step comprises:
pressing the manufacturing element on a detection element to generate a plurality of indentation patterns, and converting the indentation patterns into a plurality of image data to calculate a first image feature value of the manufacturing element corresponding to a first work count;
generating a feature value trend according to the first image feature value corresponding to the first work count and a plurality of image feature values corresponding to different work counts that are less than the first work count;
comparing a plurality of historical feature value trends to find a reference historical feature value trend that is most similar to the feature value trend; and
calculating a work count of unqualified work that is potentially generated by the manufacturing element by using the reference historical feature value trend.

12. The manufacturing method according to claim 11, wherein a maximum work count corresponding to at least one of the historical feature value trends is greater than the first work count.

13. The manufacturing method according to claim 11, wherein the detection step further comprises:
generating the feature value trend by using a linear regression method.

14. The manufacturing method according to claim 11, wherein comparing the historical feature value trends to find the reference historical feature value trend that is most similar to the feature value trend comprises:
comparing to find the reference historical feature value trend by using dynamic time warping.

15. The manufacturing method according to claim 11, wherein comparing the historical feature value trends to find the reference historical feature value trend that is most similar to the feature value trend comprises:
comparing to find the reference historical feature value trend according to a plurality of slopes and a plurality of intercepts of the historical feature value trends.

16. A manufacturing method of an electronic device, wherein the manufacturing method comprises a detection step for detecting a manufacturing equipment, wherein the detection step comprises:
providing a plurality of manufacturing equipment, wherein each of the manufacturing equipment has a plurality of historical feature value trends, and generating a plurality of changing trends of the manufacturing equipment by using a plurality of feature values corresponding to a same evaluated work count among the historical feature value trends of each of the manufacturing equipment;
generating a threshold by using the changing trends; and
comparing the changing trends and the threshold and generating a comparison result.

17. The manufacturing method according to claim 16, wherein the detection step further comprises:
obtaining slopes of the a plurality of changing trends by using a linear regression method.

18. The manufacturing method according to claim 17, wherein generating the threshold by using the changing trends comprises:
using the slopes of the changing trends as a plurality of deterioration values of the manufacturing equipment;
obtaining a plurality of valid deterioration values from the deterioration values; and
setting the threshold according to the valid deterioration values.

19. The manufacturing method according to claim 18, wherein:
the valid deterioration values comprise a first deterioration value and a second deterioration value,
the first deterioration value is different from the second deterioration value, and
the threshold is greater than the first deterioration value and less than the second deterioration value.

20. The manufacturing method according to claim 16, wherein generating the threshold comprises:
calculating the threshold by using a cumulative distribution function and a maintenance probability of the manufacturing equipment.
